(19) United States
(12) Patent Application Publication
(10) Pub. No.: US 2004/0153451 A1
(43) Pub. Date: Aug. 5, 2004

(54) Methods and systems for sharing data

(76) Inventors: John Phillips, Denver, CO (US); Mark W. Lemmons, Arvada, CO (US); Zachary T. Nies, Arvada, CO (US)

Correspondence Address: COCHRAN FREUND & YOUNG LLC, 3555 STANFORD ROAD, SUITE 230, FORT COLLINS, CO, 80525, US

(21) Appl. No.: 10/716,197

(22) Filed: Nov. 17, 2003

Related U.S. Application Data
(60) Provisional application No. 60/472,966, filed on May 22, 2003.
(60) Provisional application No. 60/319,701, filed on Nov. 15, 2002.

(51) Int. Cl. G06F 7/00

(52) U.S. Cl. 707/8

(57) ABSTRACT

Methods and systems for sharing data can maintain effective levels of security and privacy. A sharer, intending to make a selection of data available for sharing, generates a token that represents the selection of data. The sharer can provide the token to intended recipients. Recipients, upon receipt of a token, may redeem the token for the selection of data and may share the token with others who also require shared access to the selection of data.

### REFERENCE TO RELATED APPLICATION

This application claims the benefit under 35 U.S.C. §119 of U.S. patent application Nos. 60/472,966 entitled “SYSTEM AND PROCESS FOR SENDING ELECTRONIC MESSAGING ATTACHMENTS” filed 22 May 2003 and 60/319,701 entitled “SYSTEM AND PROCESS FOR SENDING ELECTRONIC MESSAGING ATTACHMENTS”, filed 15 Nov. 2002, both of which are hereby incorporated by reference herein.

### TECHNICAL FIELD

This invention relates to sharing electronic data in computerized environments. Embodiments of the invention provide methods and systems for sharing selections of electronic files and/or folders. Methods and systems according to preferred embodiments of the invention are suitable for use in contexts where security, privacy and convenience are all important.

### BACKGROUND

In a computerized environment, many activities require sharing of data. Shared data may include: documents, images, video, audio, database records as examples. Data is often organized using electronic files or records in databases. These data containers are typically kept in an electronic storage facility accessible by a computer system. Owners of data typically require that their data be kept secure and private to themselves. If the data is to be made available to others then access is limited to those others for whom access has been pre-authorized.

There are many examples in the prior art of computerized systems for maintaining security and privacy of data. Some examples include:

systems which restrict physical access to storage, computer and network systems;

systems which restrict communication access to computer and network systems to those with password-protected user accounts; and,

systems which restrict access to electronic files or data processing applications using access control lists, passwords, or other authenticating mechanisms.

Once the intent to share data with others exists, the key steps to effect sharing are:

a sharer makes the data available for sharing;

the sharer communicates the intent to share data with recipients; and,

the recipients obtain the shared data. Sharing data presents challenges of security, privacy and convenience. These challenges vary depending on the computerized environments of the sharer and the recipients.

Making data available for sharing can involve many challenges. A major challenge is the effort and complexity required to selectively circumvent the security and privacy mechanisms provided by the sharer's computerized environment so that a recipient can access the shared data. Depending on the degree of security or privacy a sharer desires for the data, the effort and complexity can be minor or significant. At one extreme, the sharer can publish the data on a publicly available storage facility, such as an internet web server. This entails obtaining the privilege to post information, copying the information to a location known to the web server and configuring the application to make the data available. Additional security can be provided by protecting the data with a password, but additional effort must be expended to secure the data with a password. Passwords are often easily lost, misinterpreted by the recipient or created in a manner that is easily guessed. At another extreme, the sharer can iteratively add the intended recipients to a list of those entitled to access the original data. The effort for this extreme can be protracted as additional recipients are identified later. The complexity increases as recipients identify others that need to share the data, as the sharer may need to be contacted to authorize access.

Another challenge is that intended recipients may have no physical or communication access with the computer system storing the shared data. Again, tradeoffs between convenience and security may be made. In some cases the sharer does not have the authority to make those tradeoffs. For example, when private data is stored on a sharer's computer inside a company's local network, the company's network administrator likely will not permit an intended recipient, using a computer outside the local network, to have communication access with the local network or the sharer's computer. Even if access is permitted, the methods for enabling this are typically complex, involving establishing user accounts, configuring physical access and communication access.

Another challenge is that the shared data may not be static or may not be statically located. For example, the sharer may intend to share a specific version of a document while continuing to edit it. This challenge may be addressed by making a copy of the shared data. The copy must then be stored in a place where it can be later located by a recipient. This can be problematic as a sharer must consume additional storage resources, may inadvertently move or remove the copy, or may forget to remove the copy after it has been shared so that resources are not consumed longer than necessary.

Another challenge is that the shared data may actually be a selection of independent data items. Editing access control lists for a large collection of files can be a time consuming and error prone task.

Assuming data is available for sharing, challenges can arise with communicating the intent to share. Communication can take many forms, examples including: physical delivery of information, audio or video communication, and electronic communication. In a computerized environment, physical delivery is sometimes used but the volume of information that can be transmitted in this manner is limited to the storage capacity of the media that is physically delivered. Audio and video communication is suitable for some forms of information but is also limited in volume by the bandwidth of the communication channel. Electronic communication is suitable for most forms of information that can be digitized but also suffers from communication channel bandwidth limitations. Electronic communication is perhaps the most common form in a computerized environment, with email and instant messaging being amongst the most popular modes of electronic communication. If the communication only includes information about the intent to share, all of these forms of communication are suitable.

It is common in the prior art for shared data to be included in communications which convey the intent to share. This is often done to overcome the challenges with making data available for sharing. In short, the sharing setup activities are simplified by adding the data to an existing communication. The tradeoff made with this approach is that including shared data in, for example, e-mail messages, consumes resources, often at an inopportune time, proportional to the number of intended recipients. Communications resources are most severely affected and unfortunately are affected at a time of the sharer's choosing. For example, a large file attached to an email, delivered to twenty people, may require that communication channels between 20 or more computer systems must immediately allocate capacity for the large message. Data storage resources are also affected when the data is included in the communication, which can be problematic if only some of the recipients need the information or if some recipients need only part of the information. The storage problem extends beyond the sharer and recipient to other systems, such as email servers, that store copies of the data for each recipient in temporary and permanent user communication archives.

The prior art includes a number of approaches for addressing some of these challenges. One approach, illustrated by data compression, enables a selection of data files to be compressed into a single file (e.g. a zip file). The compressed data file may then be delivered through a file serving application or delivered in a communication. In both cases, the entire selection of data is communicated to the recipient. In the first scenario, a tradeoff between security, privacy and convenience is made by the sharer when determining the method for making the data available. In addition, the location of the shared data is fixed at a location, making reorganization of the shared data storage facility difficult without affecting the convenience of the sharer and/or the recipients. In the second scenario, the sharer establishes his convenience as a priority relative to recipient convenience and resource consumption.

Another approach, illustrated by Lamming et al. (U.S. Pat. No. 5,862,321), teaches a tightly integrated data sharing system aimed at optimizing portable device resources and document security. The system of Lamming et al. includes:

a database of documents and tokens, each token providing a compact reference to a document in the database;

a set of devices, assigned to users that are configured in the system;

a document handling subsystem for users to create new documents and their tokens, and exchange tokens for documents at a time of a recipient's choosing; and

a security system for authenticating users as trusted users of the system.

This approach addresses some of the challenges described above but has limitations. A major limitation is that a recipient must be authenticated by the system. The time, expense and effort to establish broad-based user authentication in such a system will be a challenge, especially when the need for sharing with a user is unexpected or infrequent. Another limitation is that a separate token is required for each document. Another limitation is that documents are referenced by including a storage address (e.g. a URL) in the token. This means that a document, referenced by a token, cannot be relocated without the token being regenerated.

Lambert et al. (PCT patent application WO 00/75779 A2), teach a tightly integrated data processing system aimed at using data tokens to reference and control user manipulation of data. Lambert et al. provide:

a method for storing data objects to be processed;

a method for generating a token containing information about the data object, and what operations on the data object are permitted; and,

a method for a recipient to operate on a data object referenced by a token.

This approach addresses some of the challenges discussed but relies on authentication schemes for security and privacy, which are less convenient for end users. Lambert et al. also describe a method of associating a token with one data object. Lambert et al. discuss redactability of data objects but this relates to the sharer deciding which portions of the data object are available to specific recipients.

Another approach, illustrated by peer-to-peer file sharing systems, teaches a loosely integrated file sharing system. These systems trade off security for convenience. Shared data is publicly available and easily discovered.

As discussed there are a variety of methods and systems in the prior art that attempt to address the various challenges associated with sharing data while maintaining the security of the data and convenience for the users. Each of these approaches makes a trade off at the expense of one characteristic or another. Thus, a need exists for methods and systems to enable sharing that provide a better balance of security, privacy and convenience.

### SUMMARY OF THE INVENTION

This invention provides methods and systems for sharing data. Some preferred embodiments provide secure and private means of sharing data without compromising convenience and resource utilization. A system according to one embodiment of the invention includes:

a mechanism which a sharer can use to select data (e.g. files and folders) to be shared. The mechanism may be provided by an application in an operating system or a system component called a tokenizer herein.

a bundle server that stores a selection of data in a storage container, which may be called a bundle. The bundle server assigns the bundle an identifier that is substantially unguessable, and provides a mechanism for retrieving a bundle when presented with the bundle identifier corresponding to the bundle.

a tokenizer that produces a token that represents the bundle. The token includes, among other things, the bundle identifier. The token can be delivered to a recipient by any suitable method (e.g. e-mail attachment).

a redeemer that interacts with a bundle server to retrieve some or all of the contents of the bundle corresponding to the bundle identifier in a token. The redeemer makes the shared data available, for example by creating copies of the data in a storage facility or providing the data to an application. A recipient can use the redeemer to redeem a token at a time of his/her/its choosing.

In some embodiments of the invention a sharer can create a token corresponding to a selection of related data. As an example, the selection may include a set of documents and files relating to an activity. The documents and files in the selection may be of different types. Contextual information about the selection of data or an element of the selection of data may additionally be included in the token for the recipient's benefit. As an example, a sharer may wish to provide annotations about the selection of files or about specific files.

Some embodiments of the invention permit a recipient to selectively retrieve only the portions of the data from the container that are relevant to the recipient. This allows the recipient even greater convenience in determining how and when resources will be consumed.

In some embodiments of the invention, a storage container is freely available to anyone who possesses its token. Thus, there is no incremental effort required to share information with a new recipient. However, the storage container may only be accessed by presenting its identifier, whose value is completely unrelated to the content it holds, the sharer that generated it or the location where it is stored. The range and distribution of possible identifiers is structured so that it is prohibitive to try and guess a valid identifier for a storage container.

The storage container may be portable. In some embodiments of the invention, if the container has been moved or the computer system providing access to the storage container has changed then searching methods are used to locate the storage container in alternative storage locations.

Systems according to the invention may be constructed so that they can share data without modification to normal network security policies. Such systems may include a public communication relay service that facilitates communication between storage location and recipient computer systems, located on separate computer sub-networks, each of which do not permit unauthorized communications originating from outside their sub-network.

Systems according to the invention may have a loosely coupled architecture. This reduces the setup time required to implement such systems on a small scale (e.g. a few users sharing a few files in a local network) while enabling larger scale use (many users sharing many files across many sub-networks) to also be practiced with the same system without requiring incremental setup effort by the end users.

These and other aspects of the invention and features of embodiments of the invention are illustrated in greater detail in the detailed description.

### BRIEF DESCRIPTION OF DRAWINGS

In drawings which illustrate non-limiting embodiments of the invention:

FIG. 1 is a schematic diagram representation of a plurality of interconnected computer systems according to one embodiment of the invention.

FIG. 2 is a flowchart illustrating a method for sharing data according to one embodiment of the invention.

FIG. 3A is a block diagram illustrating one system according to the invention which includes two computer systems.

FIG. 3B is a block diagram illustrating another system according to the invention which includes several computer systems.

FIG. 4 is a data structure diagram for a bundle according to one embodiment of the invention.

FIG. 5 is a data structure diagram for a token according to one embodiment of the invention.

FIG. 6 is a block diagram illustrating a system including a relay service according to one embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

The invention provides methods and systems for sharing data between entities. Systems, according to a preferred embodiment, provide methods for a sharer entity to make data available for sharing by recipient entities. Such systems generate a token representing data to be shared. The token contains information which can be used to identify a storage container holding information about the data to be shared. A sharer can deliver the token to intended recipients by any suitable method.

Systems, according to some embodiments, allow any entity possessing a token to retrieve the contents of the storage container corresponding to the token. The data to be shared may comprise electronic files stored by a computer system. In other embodiments, data to be shared may include data organized by schemes other than a file system scheme. Examples include: data streams, data records, and distributed data records. The entities sharing information are most typically people interacting with computer systems. In other embodiments, intelligent entities, other than people, may perform the roles of sharer and/or recipient. Examples of other entities that may play the role of sharer or recipient include software applications and programmable logic devices.

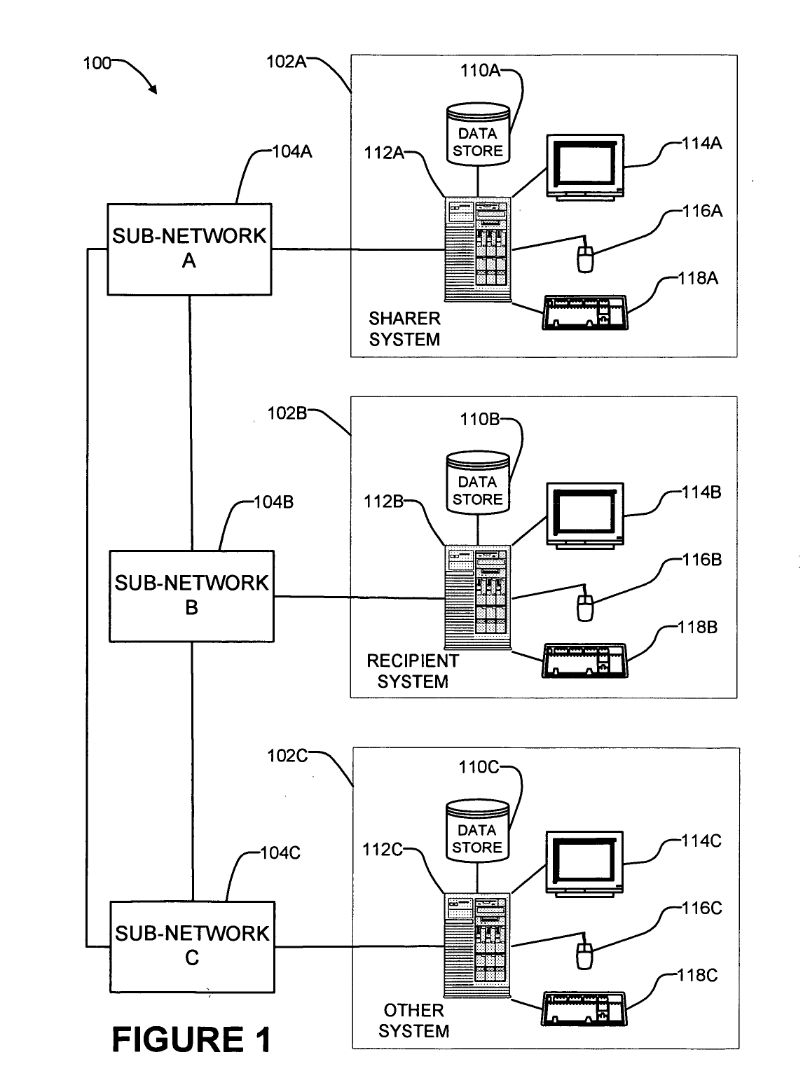

FIG. 1 is a schematic diagram illustrating a plurality of interconnected computer systems 100, corresponding to one embodiment of the invention. Blocks 102A, 102B and 102C (collectively blocks 102) represent computer systems. Blocks 104A, 104B, and 104C (collectively blocks 104) represent parts of a computer network that provides communication connections between computer systems 102A, 102B and 102C. Blocks 104 may comprise sub-networks.

One embodiment of the invention uses two computer systems 102A and 102B. Block 102A is a computer system used by a person that intends to share files with others. Block 102B is a computer system used by an intended recipient of the files to be shared. Block 102C represents one or more other computer systems which may be connected to network 104 and may be included in systems according to other embodiments of the invention, as described below.

Each computer system 102 has a processing unit 112 and a user interface comprising one or more output devices and one or more input devices. In the illustrated embodiment output devices comprise graphic display monitors 114 and input devices comprise mice 116 and keyboards 118. Each processing unit 112 has access to a data store 110, which is accessible to computer system 102 and may be part of the computer system 102.

Basic Aspect

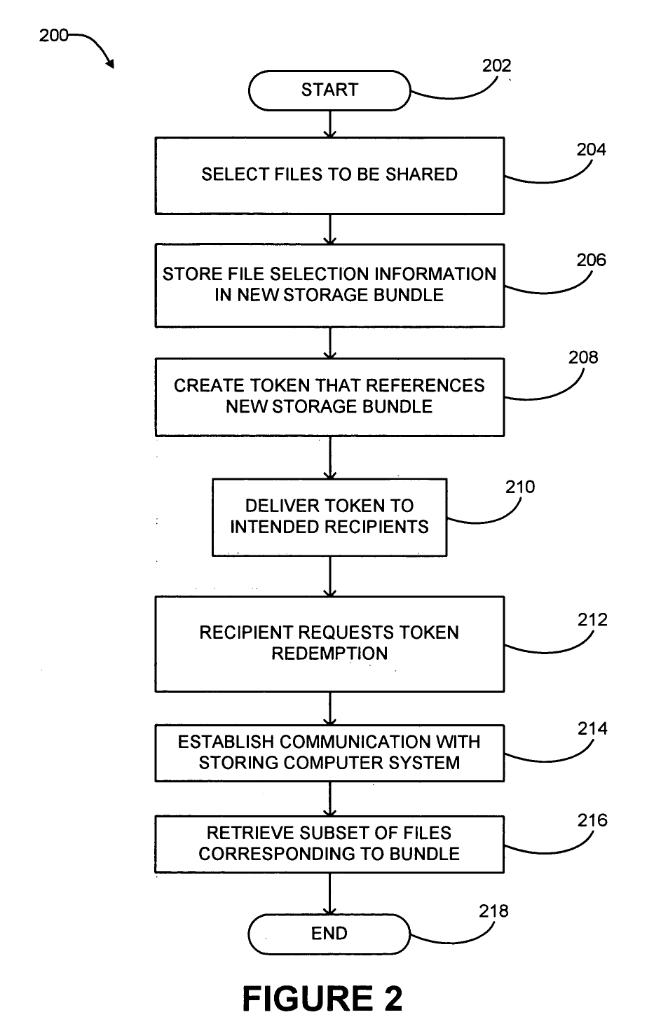

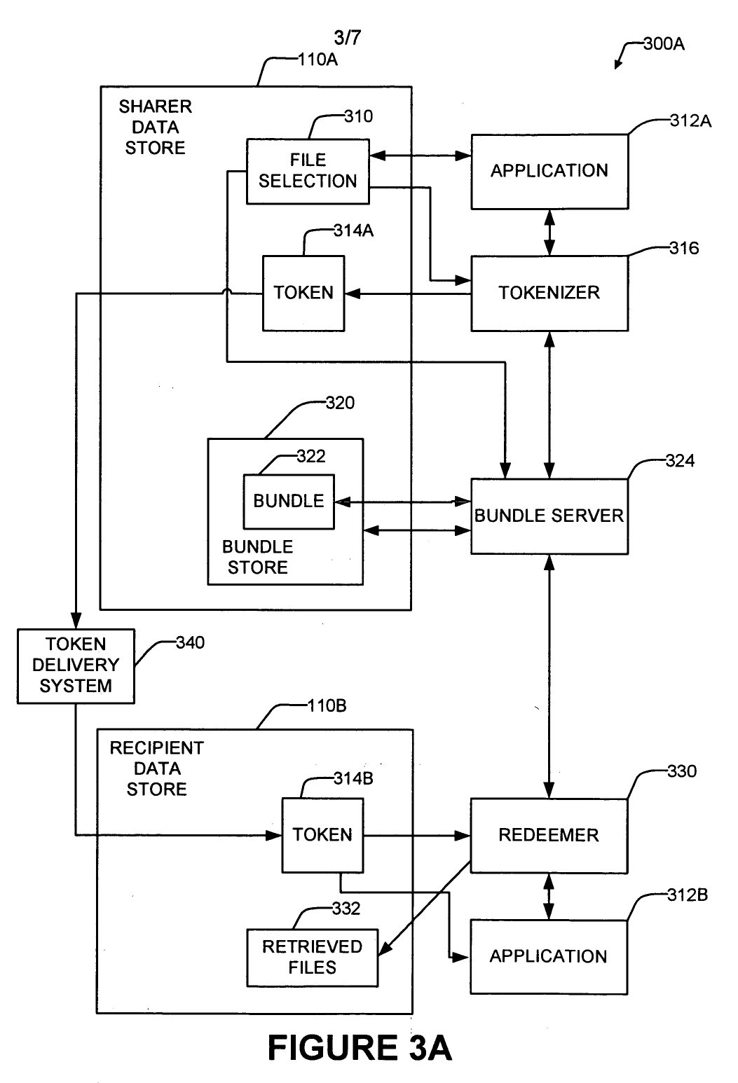

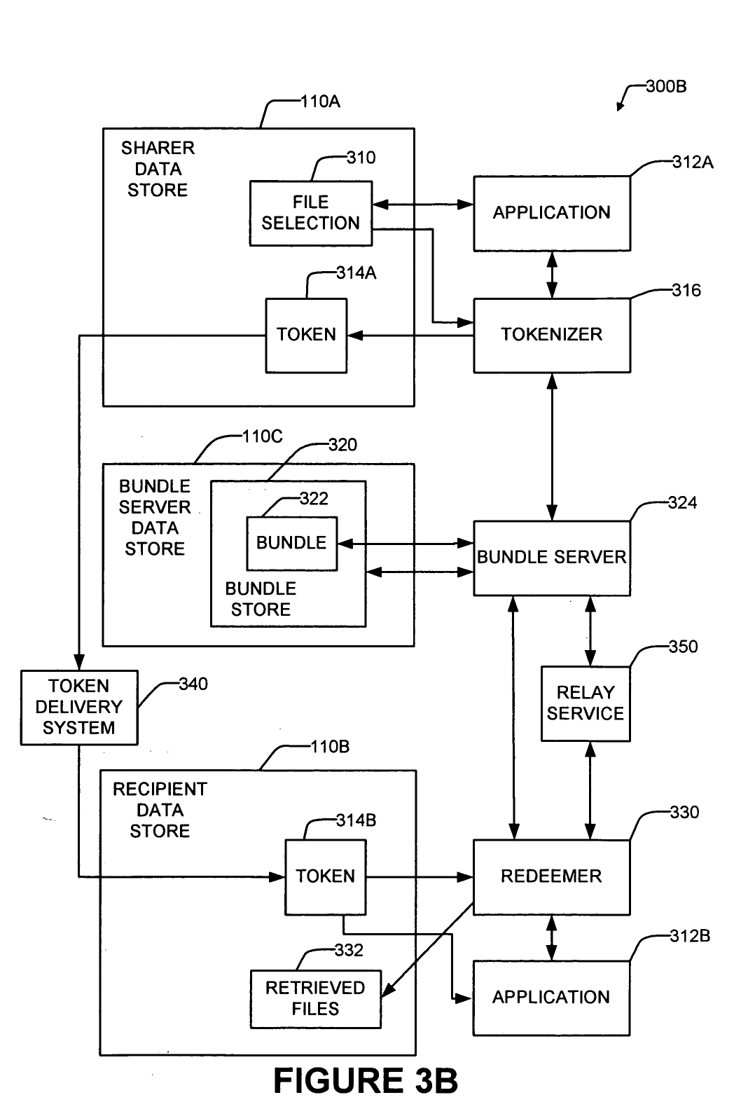

FIG. 2 is a flow chart illustrating a method 200 for sharing files according to a simple embodiment of the invention. FIG. 3A shows a system 300A according to one embodiment of the invention in which method 200 may be practised. Method 200 involves interactions of two computer systems 102A and 102B.

Method 200 begins when a sharer intends to make files available for sharing. In block 204 the sharer interacts with tokenizer 316 running on computer system 102A to identify a file selection 310 to be shared from a data store 110A (or any other data store 110 accessible to computer system 102A). Tokenizer 316 provides a user interface to present a display of folders and files from data store 110A. The sharer selects files and folders from data store 110A to identify file selection 310. File selection 310 can include any reasonable number of files and/or folders to be shared. The files may be of diverse types. By way of example, only the files may include word processing documents, spreadsheets, graphics files, video or audio files, markup language files such as HTML or XML files, executable files, and/or text files.

In block 206, tokenizer 316 requests bundle server 324 to store information corresponding to file selection 310. Stored information may include meta-data about the selected files and folders as well as the contents of the selected files. In this illustration bundle server 324 is running on computer system 102A.

Bundle server 324 organizes information about shared file selections into at least one bundle store 320 located in data store 110A. Bundle store 320 holds at least one bundle. Each bundle stores information about a corresponding file selection 310. Each bundle can correspond to a specific request to make a file selection available for sharing.

In response to the request, bundle server 324 creates new bundle 322 in a bundle store 320. Bundle server 324 stores the information provided by tokenizer 316 in bundle 322. Bundle server 324 supplies information about bundle 322, bundle store 320, and bundle server 324 to tokenizer 316.

In block 208, in response to the receipt of information from bundle server 324, tokenizer 316 creates a new token 314A comprising information about file selection 310 and information provided by bundle server 324.

In block 210, token 314A is delivered to a recipient as token 314B, by a token delivery system 340. Token delivery system 340 delivers token 314A from computer system 102A to computer system 102B. Any suitable mechanism may be used to deliver token 314B to a recipient. Example delivery methods include attaching token 314A to an email message or supplying token 314A by copying it to a portable data store for physical delivery to computer system 102B.

In block 212, the recipient uses computer system 102B to request redemption of token 314B by providing token 314B to a redeemer 330. Redeemer 330 may present a display of tokens available in data store 110B on the graphical display monitor 114B. The recipient identifies token 314B using the user interface.

In block 214, redeemer 330 establishes communication with bundle server 324 to request retrieval of bundle 322. Redeemer 330 uses information from token 314B (which was provided by bundle server 324 and stored in token 314A during block 208) to identify the required bundle. This information comprises:

a bundle server communication address, corresponding to the bundle server 324 that stored bundle 322, and,

bundle identification information, corresponding to bundle 322.

In a simple scenario, redeemer 330 establishes communication with bundle server 324 at the bundle server communication address.

Redeemer 330 requests bundle server 324 to deliver the content of bundle 322 identified by the bundle identification information. Bundle server 324 tests the bundle identification information to determine if it corresponds to bundle 322 that it serves. If the test passes, bundle server 324 replies with the content of bundle 322 in block 216. Otherwise bundle server 324 refuses the request.

Access to bundle store 320 and bundle 322 may be limited so that only bundle server 324 has access. Retrieving bundle 322 from bundle server 324 by guessing at the bundle identification information is not practically possible (i.e. is prohibitive), as described below.

In block 216, redeemer 330 retrieves the content of bundle 322 by communicating with bundle server 324. When communication is complete, the retrieved content of bundle 322 is presented for use by the recipient. In some embodiments, redeemer 330 creates folders and files, corresponding to file selection 310, as retrieved files 332 at a predefined location, such as a predefined folder, in data store 110B.

In block 218, method 200 ends with the sharer having successfully shared file selection 310 with the recipient. One advantage of method 200 is that the effort, required for both sharer and recipient is minimized. Possession of token 314 and access to a redeemer 330 is all that is required for the sharer to obtain bundle 322. Yet, access to bundle 322 is prohibitive without token 314. Another advantage is that the consumption of communication resources required to effect the sharing of data is deferred to a time of each recipient's choosing. Another advantage is that system 300A comprises loosely coupled components, allowing sharer and recipient systems to be dissimilar and allowing a wide range of communication methods, for delivering a token or for delivering the content of bundles to be used.

Other Aspects

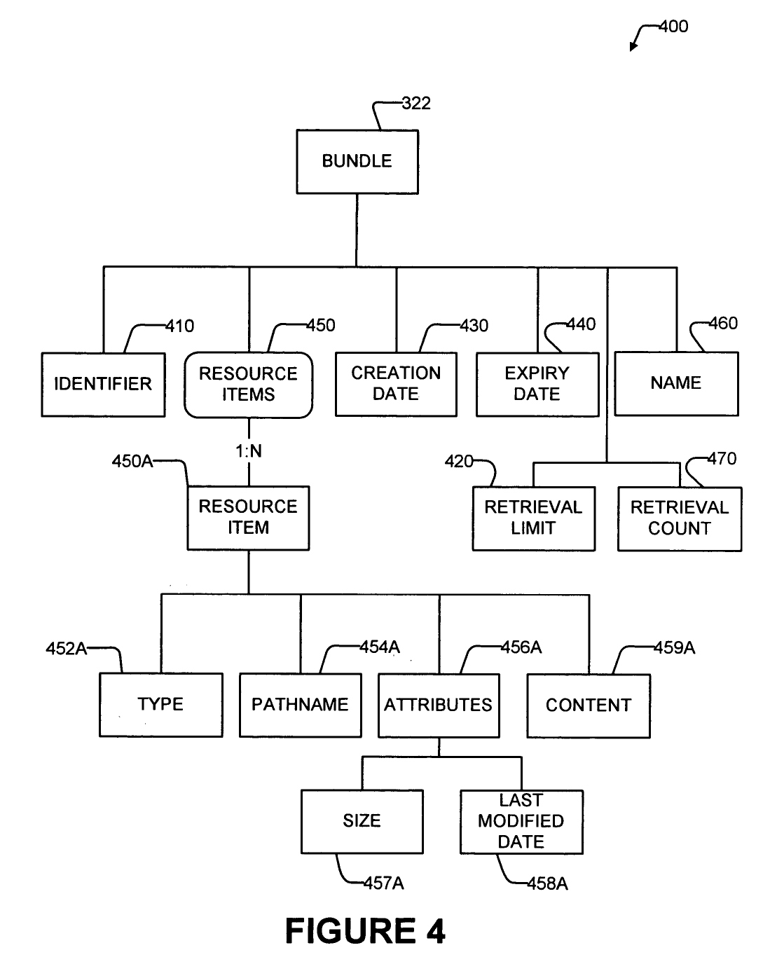

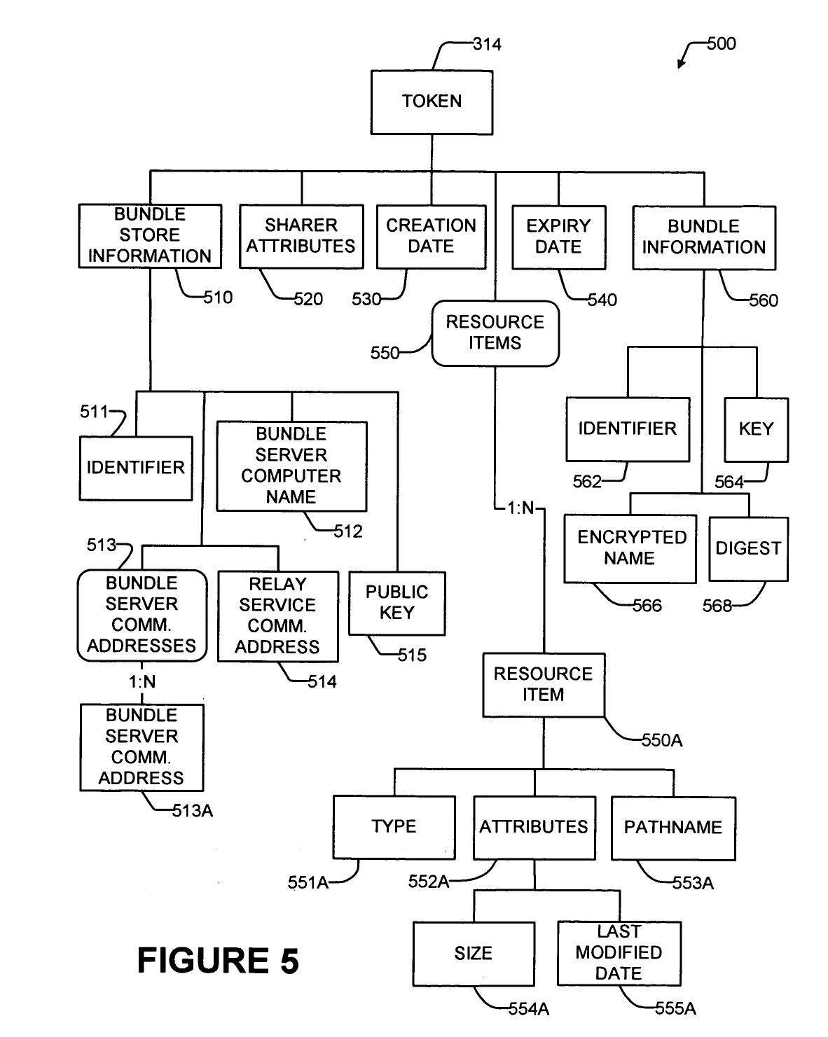

Features of methods 200 and systems 300 according to extended embodiments of the invention are described below. These aspects of the system are included to illustrate particular applications of the invention. Systems according to the invention may not have all of the features described below and may be constructed differently from the specific embodiments described below. FIGS. 4 and 5, described in further detail below, are data structure diagrams identifying the composition of a bundle and a token, respectively, in an example embodiment of system 300. Data components shown in FIGS. 4 and 5 are identified by the reference numbers used in FIGS. 4 and 5 in the following description.

System Configuration Aspects

System 300 permits a number of possible configurations. System 300A, which is described above, illustrates one configuration which includes two interacting computer systems. In another configuration, system 300 operates within a single computer system 102A. Redeemer 330 runs on computer system 102A to produce retrieved files 332 on data store 110A. This configuration enables different people using the same computer system 102A to share files with each other using method 200.

In another configuration, illustrated in FIG. 3B, the components of a system are distributed among three or more interacting computer systems. This configuration enables people to share files with each other using method 200, where bundles are stored on a computer system 102C that is different from the computer systems used by the sharer and recipient. In this configuration, method 200 differs from the basic description as follows:

In block 206, tokenizer 316 communicates with bundle server 324, located on computer system 102C.

Bundle server 324 creates bundle store 320 and bundle 322 in data store 110C.

In block 214, redeemer 330 establishes communication with bundle server 324 on computer system 102C.

Some embodiments of the invention have multiple bundle servers 324. In such embodiments, each tokenizer 316 may be configured to interact with a predefined bundle server 324. In the alternative, a tokenizer 316 may choose from among a plurality of available bundle servers 324.

File Selection Aspects

In one embodiment, an application 312A (e.g. a file system browsing application) identifies file selection 310 and provides it to tokenizer 316. In general, information described herein as being exchanged through a user interface associated with tokenizer 316 may be exchanged through an interface specific to tokenizer 316 or an interface provided by some application other than tokenizer 316.

In a preferred embodiment of block 204, file selection 310 is examined by tokenizer 316 and file selection 310 is augmented with a detailed list of subfolders and files to form the basis of bundle 322. Identifying a folder in file selection 310 causes each file, located in the determined folder, to be selected. Similarly, each sub-folder in a hierarchy of sub-folders is examined by tokenizer 316 for files and folders. Tokenizer 316 provides the augmented file selection 310 to bundle server 324. Bundle server 324 stores information about the augmented file selection 310 as resource items 450 in bundle 322. Each resource item corresponds to a file or a folder identified by file selection 310. Resource items 450 provide organization to bundle 322 to facilitate storing information about each file and folder. The information in a token 314 about each file and folder in selection 310 can be useful to the holder of a token, as described below.

In one embodiment a bundle server can store information about a resource in a bundle using either “copy semantics” or “reference semantics”. Tokenizer 316 may provide a user interface which permits the sharer to define which semantics to use. Available semantics are displayed on graphical display monitor 114A. The sharer identifies the desired semantics using the user interface. Tokenizer 316 identifies the semantics to be used to bundle server 324.

When using copy semantics, bundle server 324 copies certain information about the resource to the bundle. When using reference semantics bundle server 324 omits storing certain information about a resource. Instead, the certain information is obtained when bundle 322 is retrieved, as described below. In some embodiments, tokenizer 316 does not examine and augment the folders in file selection 310 when reference semantics are being used. Instead, this examination is deferred until bundle 322 is retrieved.

For a folder in file selection 310, the information about a resource may comprise; for example:

I) a type 452, identifying the folder as a “folder using reference semantics” or “folder using copy semantics”;

ii) a pathname 454, identifying the location of the folder in data store 110; and

iii) an attributes data structure 456, that is omitted when using reference semantics, and otherwise comprises:

a) a last modified date 458, identifying the date and time that the contents of the folder was last changed.

For a file in file selection 310, the information about a resource may comprise, for example, the same information as for a folder but with the following differences:

I) a type 452, identifying the folder as a “file using reference semantics” or “file using copy semantics”;

ii) a pathname 454, identifying the location of the file in data store 110;

iii) an attributes data structure 456, that is omitted when using reference semantics, and otherwise comprises:

a) a size 457, identifying the storage allocation required for the file; and

b) a last modified date 458, identifying the date and time that the contents of the file was last changed; and

iv) when copy semantics are being used, a content 459 which contains the data stored in the file (content 459 is omitted when reference semantics are being used).

In some embodiments only copy semantics are used. In some embodiments only reference semantics are used.

Bundle Creation Aspects

Embodiments of the invention may provide controls, which may, for example, be accessed by way of a user interface of tokenizer 316 to enable a sharer to perform one or more of the following functions:

Identify a particular bundle server 324 to be used for creating bundle 322;

Define an expiry period for bundle 322. The expiry period may support a range of times including identifying that bundle 322 should never expire. It is most practical to allow a bundle never to expire if bundle server 324 is located on the sharer's computer system 102A.

Identify a retrieval limit that specifies a maximum number of times that bundle 322 may be redeemed.

Information specified by these controls may be provided to bundle server 324 in block 206.

In a preferred embodiment, a bundle server 324 provides a plurality of bundle stores. Each bundle store may be manifested as a folder in a data store. Each bundle store may contain one file corresponding to each stored bundle. A bundle server 324 may provide a different bundle store for each of a plurality of sharers authorized to use the bundle server.

Bundle server 324 is configured to find bundle stores in one or more storage locations. For each identified bundle store, bundle server 324 maintains a bundle store table containing information about the bundle store. The bundle store table may contain entries which are each indexed by one or more organizational attribute values. The one or more organizational attribute values for each entry in the bundle store table are unique. For example, organizational attributes could comprise: sharer identity, sharer employer and sharer department. In some embodiments, sharer identity is the only organizational attribute used.

When a sharer interacts with tokenizer 316 to identify a file selection 310, information about the sharer is also obtained. This information may include one or more organizational attributes of the sharer. Tokenizer 316 automatically obtains sharer organizational attributes from processing unit 112A and may allow the sharer to change the attributes through the user interface. Tokenizer 316 provides the information about the sharer to bundle server 324 which uses the information to search its bundle store table. If a bundle store table entry is found that matches the sharer's one or more organizational attribute values, the matching bundle store table entry is used. If a matching bundle store table entry is not found, a new table entry is created comprising values corresponding to the sharer's one or more organizational attribute values.

When a matching table entry is not found, bundle server 324 also creates a new folder for bundle store 320 and stores the folder pathname in the new bundle store table entry. When bundle server 324 runs on the sharer's computer system 102, tokenizer 316 may provide a user interface for the sharer to define the bundle store folder pathname. Otherwise the bundle store folder pathname may be generated by bundle server 324 based on the sharer's one or more organizational attribute values.

When a matching table entry is not found, bundle server 324 also generates a bundle store identifier and stores the bundle store identifier in the new bundle store table entry.

When a bundle store table entry exists, bundle server 324 creates new bundle 322 corresponding to file selection 310. Bundle server 324 generates a unique bundle name, based on file selection 310, and assigns the name to the bundle file as name 460. Bundle server 324 also generates a bundle identifier and stores it in bundle 322 as identifier 410. Bundle server 324 also stores the current date in bundle 322 as creation date 430. Bundle server 324 also generates an expiry date, based on creation date 430 and the bundle expiry period, provided by tokenizer 316. The expiry date is stored in bundle 322 as expiry date 440. Expiry date 440 may be used by bundle server 324 to delete bundle 322 automatically when the current date becomes later than the expiry date. Bundle server 324 also stores the retrieval limit, provided by tokenizer 316 in bundle 322 as retrieval limit 420. Bundle server 324 supplies creation date 430 and expiry date 440 to tokenizer 316 for storing in token 314 as creation date 530 and expiry date 540, respectively.

When bundle 322 is created, bundle server 324 also generates additional information associated with aspects of retrieving bundle 322. Bundle server 324 supplies this and previously described information to tokenizer 316 for storing in token 314. This information and its use are detailed below.

Token Creation Aspects

In a preferred embodiment of block 208, token 314A is a file stored in data store 110A. In response to a bundle creation request, bundle server 324 provides tokenizer 316 with resource items 450, omitting content 459. Tokenizer 316 stores resource items 450 in token 314 as resource items 550 for use during bundle retrieval as described below. Bundle server 324 also provides tokenizer 316 with the sharer organizational attributes which are stored in token 314 as sharer attributes 520.

In one embodiment, when token 314A is created, the tokenizer user interface enables the sharer to specify a location in data store 110A to store token 314A.

In one embodiment, when token 314A is created, tokenizer 316 may optionally, at the sharer's discretion, interact with an application 312A to provide token 314A, to application 312A. As an example, application 312A may be an email client and the interaction requests that the email client create a new email message with token 314A as an attachment.

Token Redemption Aspects

In one embodiment of block 212, redeemer 330 automatically attempts to retrieve the entire bundle 322 identified by a token. In another embodiment, redeemer 330 provides a user interface that presents a display of resource items 550 on graphical display monitor 114B. The display may be generated on the basis of information in the token. The recipient selects one or more resource items, using mouse 116B or keyboard 118B, adding each corresponding pathname 553 to a retrieval list.

In one embodiment, application 312B obtains token 314B and interacts with redeemer 330 to identify a retrieval list. In general, information exchanged through a redeemer user interface may be exchanged through an application interface.

The retrieval list is provided to bundle server 324 as part of the retrieval request in block 214. In block 216 bundle server 324 communicates content 459 corresponding to each resource item in the retrieval list.

In one embodiment, redeemer 330 can use expiry date 540 to determine whether bundle 322 can be redeemed without contacting bundle server 324. Redeemer 330 does not request retrieval of bundle 322 if expiry date 540 has been reached.

When bundle 322 is created using reference semantics, blocks 212 and 214 are modified. First, redeemer 330, prior to displaying resource items 550, establishes communication with bundle server 324. Next, redeemer 330 communicates with bundle server 324 to obtain a current list of resource items 450 from bundle server 324, (rather than using the resource items 550 from token 314). Bundle server 324 examines data store 110A corresponding to resource items 450 to augment resource items 450 with current information about folders, subfolders and files. Bundle server 324 communicates the augmented resource items to redeemer 330. Next, redeemer 330 presents the augmented resource items in its user interface and the recipient selects one or more resource items. Redeemer 330 captures the selection as a retrieval list. Next, redeemer 330 requests bundle server 324 to retrieve bundle 322, providing the retrieval list. In block 216, bundle server 324 communicates file resource item content 459 from data store 110A, using pathname 454, rather than from bundle 322.

In preferred embodiments of the invention, bundle server 324 automatically processes requests for token redemptions based solely upon information from tokens 314 and does not require separate authentication information from a recipient attempting to redeem a token.

Bundle Server Communication Aspects

System 300 may have a number of optional features relating to the communication of bundles 322. One aspect relates to redeemer 330 locating bundle server 324. In a preferred embodiment, when token 314 is created, bundle server 324 provides the current bundle server computer name and bundle server communication address to tokenizer 316 to be stored in token 314 as bundle server computer name 512 and as one address in bundle server communication addresses 513. However, it is advantageous to be able to reassign computer addresses, change computer names and reallocate bundle stores 320 to different bundle servers 324.

In some embodiments bundle server 324 maintains a list of historical communication addresses it has used for bundle creations. Bundle server 324 provides these addresses to tokenizer 316 to store in bundle server communication addresses 513, as possible alternative communication addresses.

In block 214, redeemer 330 first attempts to use the bundle server communication addresses 513 to establish communication with bundle server 324. If communication cannot be established using this method, or if communication is established but the bundle server(s) at communication address(es) 513 no longer provide access to the required bundle store 320, redeemer 330 uses searching methods to establish communication with a bundle server 324 that does provide access to bundle store 320. Searching methods can comprise:

attempting communication at addresses neighboring addresses included in bundle server communication addresses 513;

attempting communication using other addresses previously used by redeemer 330; and,

attempting communication using a multicast method.

For an attempted communication, redeemer 330 sends a message, including bundle identification, to a candidate bundle server. The candidate bundle server uses at least part of the bundle identification to determine whether it provides access to bundle store 320. If access to bundle store 320 is available, bundle server 324 replies, indicating a successful attempt, and redeemer 330 establishes communication. If searching methods fail a configured relay service may be used to establish communication as described below.

When communication with bundle server 324 is established, redeemer 330 requests retrieval of bundle 322, providing the bundle identification. Bundle server 324 uses at least part of the bundle identification to locate bundle 322. If a bundle 322 is located, bundle server 324 transfers the contents of bundle 322 to redeemer 330. If bundle server 324 cannot locate a bundle 322 which matches the bundle identification than bundle server 324 refuses the request in a reply to redeemer 330.

Another aspect relates to communication disruptions that may occur while redeemer 330 is retrieving bundle 322 from bundle server 324. Redeemer 330 is able to resume a communication, during block 216, by creating a retrieval session and retrieving bundle 322 in parts. If a disruption occurs, redeemer 330 identifies the last fully received part of bundle 322 and provides that information to bundle server 324 along with a request to resume retrieval of bundle 322.

Some embodiments of the invention provide a relay service to facilitate communication between redeemer 330 and bundle server 324 when bundle 322 is retrieved. Such a relay service can permit operation when one or both of redeemer 330 and bundle server 324 are not permitted to accept unsolicited communications from outside their computer system 102 or sub-network 104. This is common when firewalls are used in computer systems 102 or sub-networks 104.

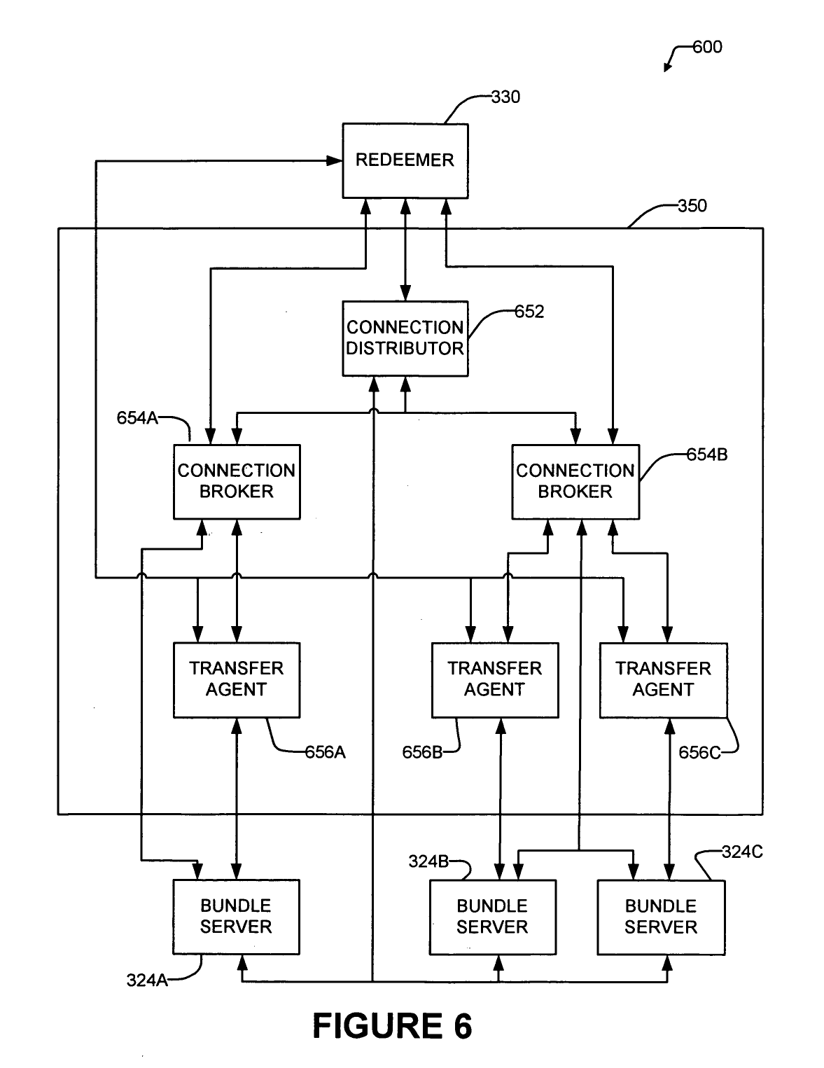

FIG. 6 is a block diagram illustrating a relay service 350 corresponding to one embodiment of system 300. System 300 may include zero or more relay services 350. A relay service 350 comprises a number of relay elements, including zero or one connection distributor 652, one or more connection brokers 654, and one or more transfer agents 656. Each of these relay elements can run on one of a plurality of computer systems 102. Configuration options range from a single computer system 102, hosting all of the relay elements, to a separate computer system 102 for each element. The function of each relay element is described below.

Connection Distributor 652, runs on a computer system 102 connected via a sub-network 104 having security provisions that allow it to receive unsolicited communications. When bundle server 324 starts, it establishes communication with a relay service 350, if it has been configured to do so. Bundle server 324 automatically initiates communication with an address which corresponds to connection distributor 652, if one exists in relay service 350, or to connection broker 654 otherwise. Connection distributor 652 maintains a list of connection brokers 654 and assigns each bundle server 324 to a connection broker 654 to distribute communication load among connection brokers 654. Bundle Servers 324 communicate with their assigned connection broker 654 directly, after receiving an assignment from connection distributor 652. For example, in FIG. 6, bundle server 324A is assigned to connection broker 654A. Similarly bundle servers 324B and 324C are assigned to connection broker 654B.

Connection Broker 654, runs on a computer system 102 connected via a sub-network 104 having security provisions that allow it to receive unsolicited communications. When bundle server 324 establishes communication with a connection broker 654, bundle server 324 provides connection broker 654 with information comprising a list of identifiers corresponding to bundle stores that bundle server 324 serves. Connection broker 654 maintains the information supplied by bundle server 324 for use when a redemption request is received. Periodically and when a bundle store is added or removed, bundle server 324 communicates with connection broker 654 to provide updated information.

In block 214 of method 200, when redeemer 330 establishes communication with bundle server 324A, redeemer 330 first attempts to directly communicate with bundle server 324. If that attempt fails, redeemer 330 then attempts to establish communication with a relay service 350 using relay service communication address 514, providing information which comprises the bundle store identifier 511. If connection distributor 652 exists, communication address 514 corresponds to connection distributor 652. Connection distributor 652 replies to redeemer 330 with an indication that redeemer 330 should communicate with connection broker 654A, previously assigned to broker requests for bundle server 324A. Otherwise, the communication address 514 corresponds to a single connection broker 654A.

When connection broker 654A receives the redemption request from redeemer 330, connection broker 654A determines if identifier 511 corresponds to one served by a communicating bundle server 324A. If a bundle store identifier is matched, connection broker 654A allocates a new transfer session and assigns it to a transfer agent 656A. Connection broker 654A replies to redeemer 330, providing information about the transfer session, transfer agent 656A, and a time period to wait before attempting communication with transfer agent 656A. The time period can be based on the time when bundle server 324A is expected to next communicate with connection broker 654A. When bundle server 324A next communicates with connection broker 654A, connection broker 654A replies with information about the pending redemption request, the allocated transfer session and the assigned transfer agent 656A. The communication between redeemer 330 and bundle server 324A is then handled by transfer agent 656A.

A transfer agent 656, runs on a computer system 102 connected via a sub-network 104 having security provisions that allow transfer agent 656 to receive unsolicited communications from at least bundle server 324 and redeemer 330. Transfer agent 656 effects bi-directional communication by buffering a request and forwarding it to the receiver when the receiver polls transfer agent 656. Both bundle server 324 and redeemer 330 are configured to periodically poll transfer agent 656A during a transfer session.

A connection broker 654 maintains a list of available transfer agents 656 and dynamically assigns redemption requests to transfer agents 656 to distribute workload among transfer agents 656. For example, in FIG. 6, redeemer 330 is using transfer agent 656B in a redemption involving bundle server 324B and transfer agent 656C in a redemption involving bundle server 324C.

Bundle Retrieval Aspects

In a preferred embodiment, bundle server 324, having received a redemption request for bundle 322, first obtains retrieval count 470 and retrieval limit 420 for the bundle. If retrieval count 470 is less than retrieval limit 420, the request is processed and retrieval count 470 is incremented. Otherwise, the retrieval request is refused.

In some embodiments, the redeemer user interface enables the recipient to define the location in data store 110B for storing retrieved files 332. The default location for locating the retrieved files can be configured to depend on information supplied to redeemer 330. For example, when token 314B is supplied to redeemer 330 from data store 110B, the default location for the retrieved files could be the same folder where token 314B is located. When token 314B is supplied to redeemer 330 from an application (e.g. an email application) the system may be configured to prompt the recipient for a location or to use a previously specified location.

In another embodiment, redeemer 330 can be configured to deliver the files to an application 312B.

In another embodiment, redeemer 330 user interface can inform a recipient that there has been a change in file selection 310 corresponding to bundle 322 that is represented by the recipient's token 314. In block 206, when copy semantics are used, bundle server 324 computes and provides tokenizer 316 with a digest of bundle 322. Tokenizer 316 stores the digest 568 in token 314. In block 216, redeemer 330 re-computes a digest using the retrieved bundle 322 to determine whether bundle 322 has changed since token 314 was generated. Redeemer 330 displays an indication of the digest comparison to the recipient. In another embodiment, a digest can be associated with each resource instead of the bundle to allow digests to be more useful for selective retrieval.

Security Aspects

System 300 may have a number of features relating to the security of bundles and tokens and the privacy of sharers and recipients.

In one embodiment the bundle identification information, generated by bundle server 324 for new bundle 322, comprises:

the bundle store identifier, stored in token 314 as identifier 511;

the bundle identifier, stored in token 314 as identifier 562; and,

an encrypted bundle name, stored in token 314 as encrypted name 566.

The bundle store identifier and the bundle identifier have values whose range of possible values is substantially large and whose values have been generated by a cryptographically strong random or pseudo-random method. The encrypted bundle name is an encrypted form of the bundle name, encrypted with the bundle store private key.

The bundle identification information is substantially unguessable. “Unguessable” means that successfully querying bundle server 324, to obtain a bundle 322 without having the bundle identification information for bundle 322, would require computer processing power and elapsed time large enough to make guessing prohibitive. The range of possible values for bundle identifiers and bundle store identifiers can be sized to provide the level of security and privacy desired. The unguessability of the bundle identifier is of greater importance in situations where a violator may attack a bundle store whose bundle store identifier is known by decoding a token associated with a different bundle in the same bundle store.

In practice, the range of possible values for the bundle identifier and/or the bundle store identifier can be chosen so that the probability of correctly guessing a valid bundle identifier/bundle store identifier is low enough to provide an acceptable level of security (e.g. one in a million guesses). The probability of correctly guessing bundle identification information corresponding to a bundle is a function of the number of bundles accessed by a bundle server and the range of possible values for the bundle identification information. The security of any bundle is a function of the probability of a correct guess and the number of guesses that can be made.

the request rate can be governed by the bundle server. Rates on the order of 10⁶ requests per second can be used as an example limit. One may assume that a violator will not be willing to continue guessing for more than one year. One may also assume that one bundle server provides access to at most 10⁶ bundles. Assume a value range on the order of 10³⁰ values. This gives a probability of 10⁻²⁴ that a single guess of some bundle accessed by a bundle server is correct. In one year, a violator could make approximately 10¹³ guesses. Depending on the context of its use, this may be an acceptable level of security. The request rate and value ranges for the bundle identification information may be adjusted to determine a suitable level of unguessability.

The bundle and/or bundle store identifier value range may be greater than or equal to 10¹⁰, greater than or equal to 10²⁰, greater than or equal to 10³⁰ or greater than or equal to 10⁴⁰. The security of a system according to the invention against attempts to guess bundle identification information can be increased by maintaining a large ratio of possible values for bundle identification information to a number of bundles in a bundle store. In some embodiments of the invention this ratio equals or exceeds 10¹⁵:1. For more security the ratio may equal or exceed, for example, 10²⁰:1, 10²⁴:1 or 10³⁰:1. The ratio may exceed a maximum number of requests for bundles that could be made in one year at a maximum request rate of the bundle server by a factor of at least 1000, or, for greater security, for example, a factor of 10⁶, 10¹⁰, or more.

In some embodiments, random values for bundle identifiers and/or bundle store identifiers are generated using the pseudo-random method of Sun™Java™s SecureRandom class, using the “SHA1PRNG” algorithm from the “SUN” cryptographic service provider. In other embodiments, pseudo-random generators having the following properties that may be equivalent to or better than Sun™Java™s SecureRandom class can be used to generate random identifiers:

multiple input sources;

input source mixing strength;

input data analysis resistance;

input data manipulation resistance;

output data analysis resistance; and

internal state analysis resistance.

In some embodiments, public/private key pairs are associated with bundle stores 320 and/or with individual bundles 322. In some embodiments these public/private key pairs are generated at the time a bundle or bundle store is created. For example, upon creating a new bundle store, bundle server 324 may generate a bundle store key pair and store the bundle store key pair in a new bundle store table entry corresponding to the new bundle store. The bundle store key pair is part of an asymmetric cryptographic system, whereby data encrypted with the bundle store private key may be decrypted using the bundle store public key and data encrypted with the bundle store public key may be decrypted by the bundle store private key but not with the bundle store public key.

In one embodiment bundle store private and public keys are generated using methods conforming to standard RSA PKCS #1 (RFC3447). In other embodiments, bundle store private and public keys are generated using methods providing equivalent or better cryptographic strength than RSA PKCS #1.

In one embodiment bundle server 324 generates a unique bundle key for bundle 322 during block 206. The bundle key may be generated as part of a symmetric cryptographic system, complying with US Federal Information Processing Standard FIPS-197, whereby data encrypted with the bundle key can be decrypted with the bundle key. The bundle key can be used to encrypt content 459 corresponding to each resource item stored in bundle 322, or corresponding to each resource item retrieved from file store 110A when using reference semantics. The bundle key is provided to tokenizer 316 for storing in token 314 as key 564. Encrypting content 459 protects the privacy of the sharer's information while stored in bundle store 320 and during retrieval.

In one embodiment a sharer can provide additional security for token 314 and bundle 322 by providing a pass-phrase to tokenizer 316. Tokenizer 316 enables a sharer to supply a pass-phrase during block 204. Tokenizer 316 encrypts token 314 using the pass-phrase during block 208. During block 212 the recipient must supply the pass-phrase in order for redeemer 330 to successfully decrypt the content of token 314.

In one embodiment a recipient's privacy can be increased during retrieval of bundle 322. The recipient's attributes (e.g. computer account name), may be automatically obtained by redeemer 330 from processing unit 112B, and may be changeable by the recipient through the redeemer user interface. The recipient's attributes may be provided to bundle server 324 by redeemer 330 in block 216. Redeemer 330 encrypts the recipient's attributes using public key 515, corresponding to bundle store 320, stored by tokenizer 316 in block 208. In one embodiment this method can be used to ensure that all communication from redeemer 330 to bundle server 324 is private.

Management Aspects

System 300 may have a number of aspects relating to the management of system 300 and the bundles it administers. One aspect relates to producing system 300 usage information. In one embodiment, bundle server 324 maintains a record of redemption requests for bundle 322. The record, for each request, can include information about the recipient and/or the recipients' computer system 102B, provided by tokenizer 316, and information about the bundle retrieval process, provided by bundle server 324 and/or relay service 350. In one embodiment this information is stored in data store 110 so that sharers may see who has redeemed their tokens. In another embodiment, the system can provide an application for a person to obtain redemption information, pertaining to bundle 322 corresponding to their file selections 310, on request or automatically.

System 300 may restrict usage or provide information to support billing for usage. In one embodiment, a relay service records the volume of data communicated by its transfer agents. The relay service can accumulate this information in groupings based on a bundle store, a bundle server or other information. A relay service can have thresholds configured for each grouping of data volume metrics, which may be used to refuse a redeemer's request or to trigger generation of information to be used for billing. In another embodiment, a bundle server can filter retrieval requests based on quotas applied to the volume of information communicated. Quotas can be established on variety of bases, examples including: a bundle and a bundle store.

Other Embodiments

The following descriptions illustrate other embodiments of the system 300 and method 200. These are provided to illustrate variations of the invention but do not limit the scope of the invention.

In one embodiment the invention is integrated with an email delivery system as illustrated in FIG. 3. For this aspect of system 300, application 312A scans email messages, queued for delivery, for file attachments. Each email massage may include zero, one or multiple attached files. Attached files, whose sizes, or whose aggregate sizes, exceed a configured threshold, are automatically placed in file selection 310 by the email application 312A and information about file selection 310 is provided to tokenizer 316. Tokenizer 316 generates a token 314 corresponding to the attachments. The attachments are automatically stored in a bundle 322 in a bundle store 324. The email application 312A substitutes the file attachments in the email message with token 314, provided by tokenizer 316, prior to delivering the message.

In this embodiment, token delivery system 340 is manifested by the transmission and reception parts of the email system. On receipt of an email message, token 314B and its association with the corresponding email message are stored in data store 110B by the reception part of the email system. The recipient's email application 312B provides a method for displaying the email message and associated token 314B, which may then be selected. Token 314B may be of a file type that is associated with redeemer 330 so that, when selected, token 314B is automatically provided to redeemer 330 for retrieval of the original message attachments.

In other embodiments, a sharer may use a bundle manager to view and alter the content of bundle 322. As an example, the bundle manager can enable a sharer to substitute an original version of a resource item in bundle 322 with a newer version. Token 314B can still be used to obtained bundle 322. A digest comparison can indicate that the retrieved content is different than the original.

In other embodiments, the organizing structure, content, and format of a bundle store, a bundle and a token can change to enhance or optimize certain aspects of the invention. Examples include: storing a bundle in a database instead of a file, compressing data to save storage space, eliminating elements to save storage space, adding elements to correspond with additional aspects, and changing elements to correspond with different data organizing methods or different communication methods. Examples include adding additional contextual information to a token comprising: low-resolution preview data corresponding to high-resolution image data from a file selection, annotations pertaining to a file selection, and references to other data potentially relevant to a file selection. In general, contextual information can be associated with the file selection, a resource item or by an arbitrary topic referencing one or more resource items. In one embodiment, a tokenizer may analyze the file selection to derive contextual information. In another embodiment, a tokenizer may provide a user or application for providing contextual information. As an example, a sharer may wish to provide annotations about the selection of files or about specific files. Since the contextual information is in the token, a recipient can review the contextual information before deciding whether to redeem the token. A recipient may use the contextual information to select a subset of resources to download.

Certain implementations of the invention comprise computer processors which execute software instructions which cause the processors to perform a method of the invention. For example, tokenizer 316, bundle server 324, and redeemer 330 may all be implemented by providing software which runs on one or more computer systems 102 and causes the computer systems to operate according to methods described above. The invention may also be provided in the form of a program product. The program product may comprise any medium which carries a set of computer-readable signals comprising instructions which, when executed by a computer processor, cause the data processor to execute a method of the invention. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for sharing data with a recipient, the method comprising:
creating a bundle, the bundle comprising information identifying a selection of data to be shared;
storing the bundle in a bundle store accessible to a bundle server, associating the bundle with a bundle identifier that is substantially unguessable and creating a token corresponding to the bundle, the token comprising the bundle identifier;
providing the token to a recipient;
receiving the bundle identifier at the bundle server from the recipient, using the bundle identifier to identify the bundle, and subsequently returning contents of the bundle to the recipient.

2. A method according to claim 1 comprising identifying a plurality of data files to be shared by receiving selection information from a sharer;
wherein the method comprises establishing a communication channel between the bundle server and the recipient and returning contents of the bundle to the recipient comprises providing a copy of the bundle to the recipient by way of the communication channel.

3. A method according to claim 2 wherein the selection information identifies a plurality of data files to be shared.

4. A method according to claim 3 wherein providing the token to the recipient is performed by way of a communication mechanism different from the communication channel.

5. A method according to claim 3 wherein the token is provided to the recipient as an attachment to an e-mail communication.

6. A method according to claim 3 wherein the token comprises a token file of a type associated with a token redeemer wherein, selection of the token file invokes the token redeemer.

7. A method according to claim 1 comprising providing the token to a plurality of recipients and repeating redeeming the token for two or more of the plurality of recipients.

8. A method according to claim 1 wherein associating the bundle with a bundle identifier comprises creating a bundle identifier having a value selected from among at least 10²⁰ possible values.

9. A method according to claim 8 wherein the bundle identifier has a value selected from among at least 10³⁰ possible values.

10. A method according to claim 9 comprising maintaining a ratio of a number of the possible values to a number of bundles in the bundle store to be at least 10²⁰:1.

11. A method according to claim 8 comprising maintaining a ratio of a number of the possible values to a number of bundles in the bundle store to be at least 10¹⁵:1.

12. A method according to claim 11 wherein the ratio of a number of the possible values to a number of bundles in the bundle store exceeds a maximum number of requests for bundles that could be made in one year at a maximum request rate of the bundle server by a factor of at least 1000.

13. A method according to claim 1 wherein returning the bundle to the recipient is performed automatically based solely upon information from the token.

14. A method according to claim 1 comprising including in the token a plurality of token resources, the token resources each identifying a corresponding one of a plurality of data items in the selection of data.

15. A method according to claim 14 comprising receiving from the recipient a request for a subset of the data items of the selection of data wherein and returning the contents of the bundle to the recipient comprises providing copies of the subset of the data items to the recipient.

16. A method for sharing data with one or more recipients, the method comprising:
identifying a selection of data to be shared;
creating a bundle, containing information about the selection of data, and storing the bundle in a location accessible by a bundle server;
associating bundle identification information with the bundle, the bundle identification information being substantially unguessable;
creating a token representing the bundle, the token including the bundle identification information; and
a recipient obtaining the token and communicating with the bundle server, the communicating comprising requesting the bundle from the bundle server at least in part by providing the bundle identification information from the token; and
providing a copy of the bundle to the recipient having the token.

17. A method according to claim 16 wherein creating the bundle comprises:
storing the bundle in a bundle store, the bundle store associated with a bundle store sharer identity, the bundle store sharer identity being unique among a plurality of bundle store sharer identities corresponding to a plurality of bundle stores accessible to the bundle server, the bundle store containing one or more bundles, corresponding to a sharer, the sharer having a sharer identity, matching the bundle store sharer identity.

18. A method according to claim 17 wherein the bundle store is associated with a bundle store key pair generated by an asymmetric encryption system, the key pair including a bundle store public key and a bundle store private key wherein creating the token comprises including the bundle store public key in the token.

19. A method according to claim 18 wherein the bundle identification information comprises a bundle identifier comprising a value generated randomly within a substantially large range of possible values;
a bundle store identifier comprising a value generated randomly within a substantially large range of possible values; and
an encrypted bundle name, corresponding to a bundle name associated with the bundle, the encrypted bundle name generated using the bundle store private key.

20. A method according to claim 16 wherein the bundle identification information comprises a bundle identifier comprising a value generated randomly within a substantially large range of possible values.

21. A method according to claim 20 wherein the range of possible values includes in excess of 10²⁰ possible values.

22. A method according to claim 21 wherein providing the copy of the bundle comprises:
obtaining the bundle identification information for the bundle;
identifying a candidate bundle, the candidate bundle having associated candidate bundle identification information; and
communicating a copy of the candidate bundle to the recipient if the candidate bundle identification information matches the requested bundle identification information.

23. A method according to claim 16 wherein the token includes a plurality of token resources, corresponding to a plurality of bundle resources and communicating with the bundle server comprises:
selecting a subset of the token resources,
requesting a subset of the one or more bundle resources corresponding to the subset of the token resources; and,
providing the subset of the one or more bundle resources to the recipient having the token.

24. A method according to claim 23 wherein the token includes a selection context providing information about the selection of data.

25. A method according to claim 23 wherein the token includes one or more topic contexts, the one or more topic contexts referencing one or more token resources.

26. A method according to claim 23 wherein the token includes one or more relationship contexts, the one or more relationship contexts referencing a plurality of token resources.

27. A method according to claim 16 wherein the token includes a plurality of bundle server communication addresses corresponding to a bundle server having access to the bundle and the method comprises establishing communication with the bundle server by attempting communication with the bundle server using different ones of the plurality of bundle server communication addresses until communication is established with the bundle server.

28. A method according to claim 16 comprising establishing communication with the bundle server using a searching method, the searching method comprising attempting communication with the bundle server at each of a plurality of candidate addresses to determine if a candidate address corresponds to the bundle server.

29. A method according to claim 16 wherein establishing communication with the bundle server having access to the bundle comprises using a relay service, the relay service comprising:
a mechanism capable of receiving unsolicited communications from a plurality of parties;
establishing a bundle server protocol with a plurality of bundle servers to receive ongoing communications from the plurality of bundle servers;
storing a communication from a recipient to a destination bundle server, the destination bundle server observing the bundle server protocol;
establishing a recipient protocol with the recipient to receive ongoing communications from the recipient;
replying to an ongoing communication from the destination bundle server, providing the stored communication from the recipient to the destination bundle server;
storing a communication from the destination bundle server to the recipient; and
replying to an ongoing communication from the recipient, providing the stored communication from the destination bundle server to the recipient, whereby communication is facilitated between a recipient and a destination bundle server that do not permit unsolicited communication.

30. A method according to claim 16 comprising, before providing the token to the recipient, encrypting the token so that the token can be decrypted with the use of a pass-phrase.

31. A method according to claim 16 wherein creating a bundle comprises:
generating a bundle key;
encrypting at least a part of the bundle using the bundle key; and,
storing the bundle key in the token.

32. A method according to claim 18 wherein communicating with the bundle server comprises:
receiving one or more communications at the bundle server, the communications encrypted with the bundle store public key; and
sending one or more communications from the bundle server, the communications encrypted with the bundle store private key.

33. A method according to claim 16 wherein the bundle includes:
a retrieval limit and a retrieval count and the method comprises inhibiting providing the copy of the bundle if providing the copy of the bundle would cause the bundle count to exceed the retrieval limit.

34. A method according to claim 33 comprising:
incrementing the retrieval count each time a copy of the bundle is provided to a recipient.

35. A method according to claim 16 wherein:
the bundle is associated with:
a retrieved data quota, and a total retrieved data amount, based on an accumulation of retrieved data amounts corresponding to the bundle; and
the method comprises inhibiting providing the copy of the bundle if providing the copy of the bundle would cause the total retrieved data amount to exceed the retrieved data quota.

36. A method according to claim 16 wherein the token includes an expiry date.

37. A method according to claim 36 wherein communicating with the bundle server comprises:
obtaining a current date, and,
communicating with the bundle server only if the expiry date is later than the current date.

38. A method according to claim 16 wherein the bundle includes an expiry date and the method comprises:
periodically obtaining a current date at the bundle server; and,
deleting one or more bundles, for which the expiry date is earlier than the current date.

39. A method according to claim 16 wherein the bundle comprises one or more bundle resources and creating a token comprises:
computing a bundle digest based on the one or more bundle resources;
storing the bundle digest in the token.

40. A method according to claim 39 wherein receiving a copy of the bundle comprises:
computing a bundle copy digest based on the one or more bundle resources in the copy of the bundle, and
comparing the bundle digest and the bundle copy digest.

41. A computerized system for sharing data with a plurality of recipients, the system comprising:
means for receiving from a sharer an identification of a selection of data to be shared;
means for creating and storing a bundle, containing information about the selection of data;
means for creating a bundle identification information and an associating it with the bundle, the bundle identification being substantially unguessable;
means for creating a token representing the bundle, the token including the bundle identification information; and
means for receiving from a recipient a request for the bundle identified by the bundle identification information from the token; and,
means for providing to the recipient a copy of the bundle in response to the request.

42. An apparatus for sharing a plurality of selections of data, the apparatus comprising:
a plurality of bundle servers, each of the bundle servers configured for:
creating a bundle,
storing information about a selection of data in the bundle;
generating a bundle identification that is substantially unguessable and associating it with the bundle; and
communicating the information about a selection of data in the bundle when provided with a requested bundle identification corresponding to a bundle that is accessible by the bundle server;
a plurality of tokenizers, each of the tokenizers configured for:
identifying a selection of data from a sharer;
providing the selection of data to a bundle server to create a bundle;
obtaining the bundle identification from the bundle server;
creating a token representing the bundle, the token including the bundle identification; and
providing the token to the sharer; and
a plurality of redeemers, each of the redeemers configured for:
obtaining a token;
establishing communication with a bundle server having access to the bundle, and communicating with the bundle server, communicating comprising:
requesting the bundle identified by the bundle identification in the token; and
receiving a copy of the bundle, whereby receiving depends on having the token.

43. A medium carrying a set of computer-readable signals comprising instructions which, when executed by a data processor, cause the data processor to execute a method according to claim 1.
